(19) United States
(12) Patent Application Publication
(10) Pub. No.: US 2006/0239036 A1
(43) Pub. Date: Oct. 26, 2006

(54) Lamp seat assembly for a projection apparatus

(75) Inventor: Wen-Wei Tsai, Miao Li County (TW)

Correspondence Address: BIRCH STEWART KOLASCH & BIRCH, PO BOX 747, FALLS CHURCH, VA, 22040-0747, US

(73) Assignee: Coretronic Corporation

(21) Appl. No.: 11/405,560

(22) Filed: Apr. 18, 2006

(30) Foreign Application Priority Data
Apr. 22, 2005 (TW) 94112916

(51) Int. Cl. H01R 33/00

(52) U.S. Cl. 362/655; 362/659

(57) ABSTRACT

A seat assembly is used for seating a bulb unit securely within a projection apparatus. The bulb unit has two conductive legs. The seat assembly includes a bottom seat for holding the bulb unit thereon, and a power connector that is disposed on the bottom seat for connecting electrically to a power supply of the projection apparatus. The power connector is capable of coupling electrically to the conductive legs of the bulb unit.

### FIELD OF THE INVENTION

The invention relates to a seat assembly, and more particularly to a lamp seat assembly for seating a bulb unit securely within a projection apparatus.

### BACKGROUND OF THE INVENTION

A bulb unit is provided in a projection apparatus in order to produce light beams required for projecting an image. The bulb unit is usually seated within a lamp seat assembly in the projection apparatus.

FIG. 1 illustrates the bulb unit 4 is seated on a conventional seat assembly 2. The conventional seat assembly 2 generally includes a bottom seat 6 and a power connector 8. A rectangular mounting frame 10 is fixed on the bottom seat 6. The peripheral portion of the bulb unit 4 is fastened to the mounting frame 10 through a plurality of screws 11a in order to fix the bulb unit 4 the bottom seat 6 to form a bulb module. The bulb module does not permit replacement single component of the bulb module, but rather the entire bulb module must be replaced by a new bulb module once the bulb unit 4 is damaged. However, several components of the bulb module are rather durable when compared to the bulb unit. Discard of the undamaged components in the bulb module causes in material waste and pollution to the environment.

In addition, the bulb unit 4 has two conductive contacts 402 electrically connected to the power connector 8 via a connection cable 12. The power connector 8 can be connected to an external power source (not shown) for providing electrical power to the projection apparatus.

In a conventional case, the connection cable 12 is soldered to the conductive contacts 402 of the bulb unit 4 so as to establish electrical communication between the bulb unit 4 and the power connector 8. In the other conventional case, fastener screws are used to couple the connection cable 12 with the conductive contacts 402 in order to facilitate detachment of the bulb unit 4 from the bulb module. A screwdriver is needed to fasten or unfasten the screws. It is inconvenient to change the bulb unit 4.

### SUMMARY OF THE INVENTION

It is an object of the present invention to provide a lamp seat assembly for use in a projection apparatus. The lamp seat assembly includes components that are not discarded along with the damaged bulb unit during replacement of the new bulb unit.

It is an another object of the present invention to provide a lamp seat assembly that is convenient to detach and fasten the bulb unit without an operating kit such as a screw driver.

In one aspect of the present invention, a seat assembly is provided for seating a bulb unit securely within a projection apparatus. The bulb unit has two conductive legs. The seat assembly includes a bottom seat for holding the bulb unit thereon, and a power connector disposed on the bottom seat and adapted to be connected electrically to a power supply of the projection apparatus. The power connector is adapted to be coupled electrically to the conductive legs of the bulb unit.

In a second aspect of the present invention, a seat assembly is provided for seating a bulb unit securely within a projection apparatus. The bulb unit has outwardly extending left and right flanges. The seat assembly includes a bottom seat for holding the bulb unit thereon and spaced apart left and right mounting posts extending upwardly from a front end of the bottom seat to define left and right retention channels for receiving the left and right flanges of the bulb unit so as to retain the bulb unit on the bottom seat.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is a rear perspective view illustrating a bulb unit seated in a conventional seat assembly;

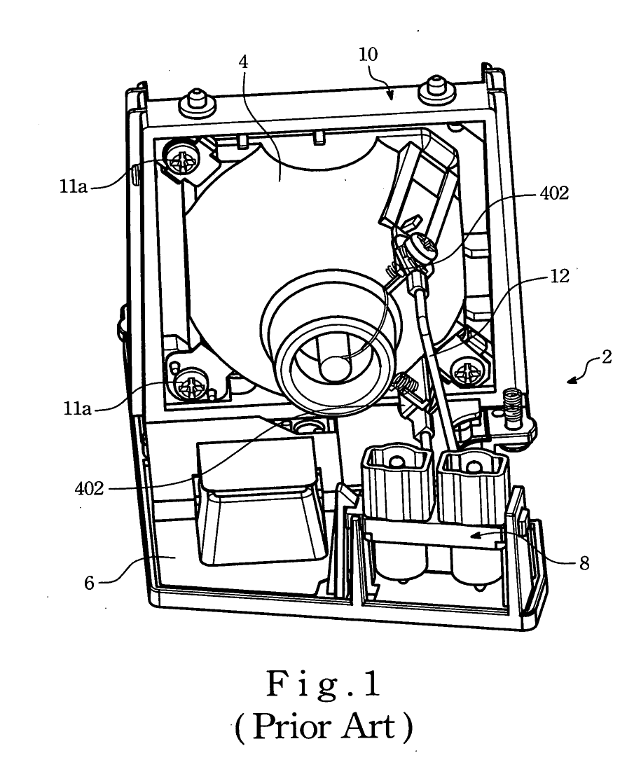

FIG. 2 is a perspective view of a bulb unit for use in the seat assembly of the present invention;

FIG. 3 is a perspective lateral view of the seat assembly of the present invention;

FIG. 4 is a perspective lateral view illustrating the bulb unit removed from the seat assembly of the present invention;

FIG. 5 is a perspective fragmentary view illustrating the bulb unit connected to a power connector in the seat assembly of the present invention;

FIG. 6 is a perspective top view of the seat assembly of the present invention with the bulb unit removed therefrom; and

FIG. 7 is a perspective lateral view of the seat assembly of the present invention with the bulb unit removed therefrom.

### DETAILED DESCCRIPTIONS OF THE PREFERRED EMBODIMENT

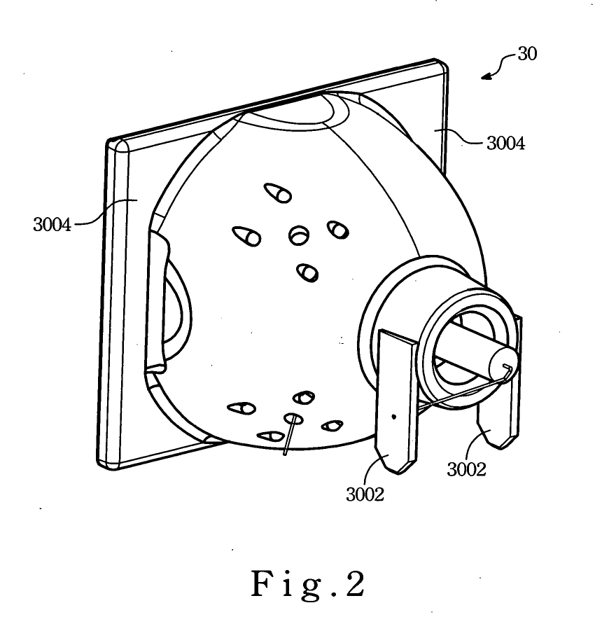

The lamp seat assembly 40 according to the present invention is used for seating a bulb unit 30 securely within a projection apparatus. As shown in FIG. 2, the bulb unit 30 has outwardly extending left and right flanges 3004 and two conductive legs 3002.

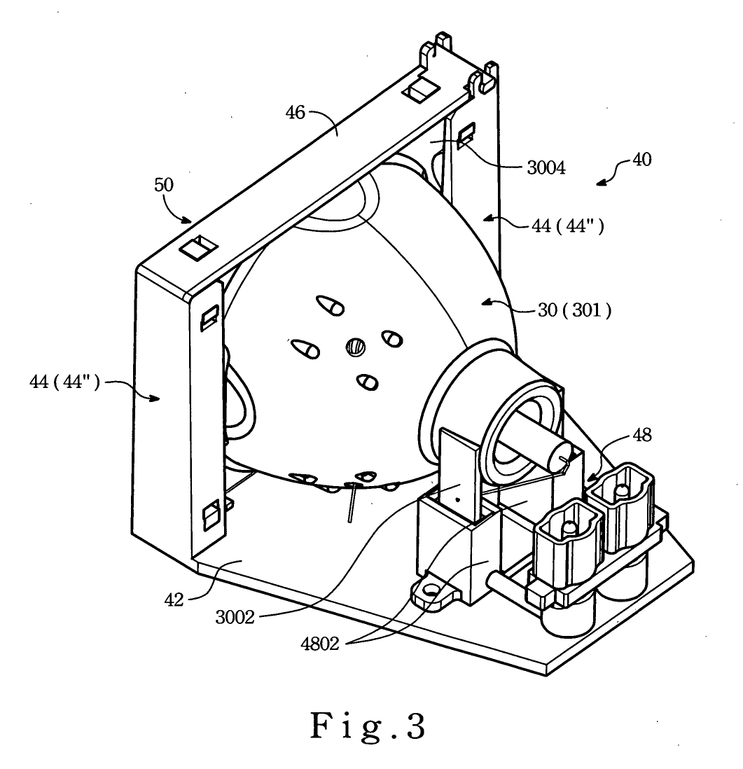

Referring to FIG. 3, the seat assembly 40 includes a bottom seat 42, two left and right mounting posts 44, a bridging post 46 and a power connector 48.

The left and right mounting posts 44 extend upwardly from a front end of the bottom seat 42 to define left and right retention channels 44″ for receiving the left and right flanges 3004 of the bulb unit 30 so as to retain the bulb unit 30 on the bottom seat 42. The bridging post 46 is disposed between and spans across the left and right mounting posts 44. The bridging post 46 has one end connected pivotally to the right mounting post 44 and the other end fastened detachably to the left mounting post 44 in order to retain the bulb unit 30 on the bottom seat 42.

The power connector 48 is disposed on the bottom seat 42 and is connected electrically to a power supply of the projection apparatus (not shown). The power connector 48 is formed with two leg-receiving sockets 4802 for respectively receiving the conductive legs 3002 of the bulb unit 30.

The bulb unit 30 includes a burner (not shown) and a lampshade 301 that is disposed behind the burner and that surrounds the burner in such a manner that the light beams emitted from the burner are directed in the frontward direction only. In this embodiment, the left and right flanges 3005 extend outwardly from left and right sides of the lampshade 301. The bridging post 46, the left and right mounting posts 44 and the bottom seat 42 cooperatively define a rectangular frame 50 for holding a front portion of the lampshade 301.

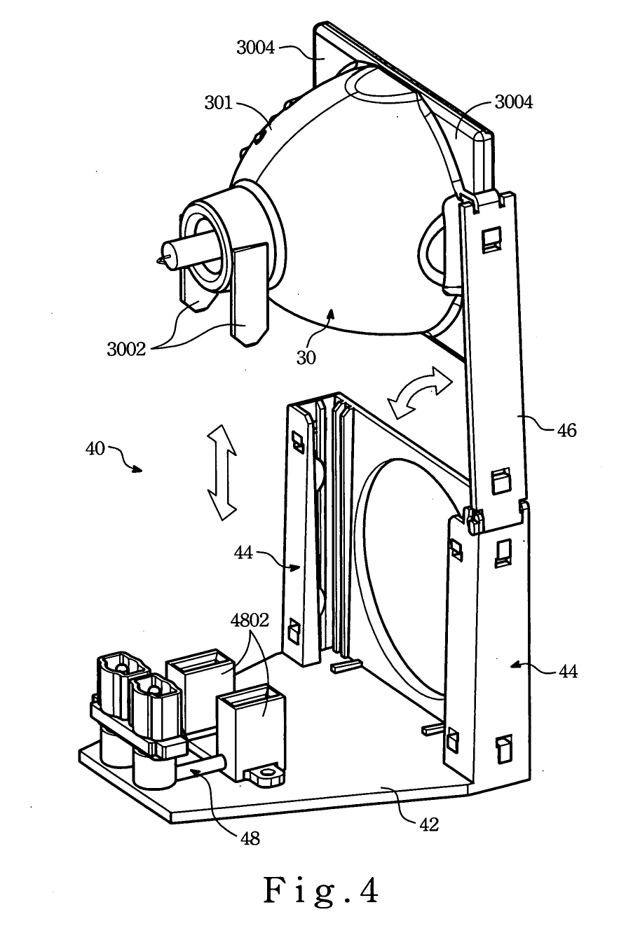

Referring to FIG. 4, when it is desired to replace the bulb unit 30 due to burn out, the bridging post 46 is unfastened from the left mounting post 44 so as to permit raising of the bulb unit 30 upward. Under this condition, the damaged bulb unit 30 can be removed so as to be replaced with a new bulb unit. Note in contrast to the conventional seat assembly, it is relatively convenient to remove the damaged bulb unit without the need to discard the left and right mounting posts 44, the bridging post 46, and the power connector 48.

In this embodiment, the conductive legs 3002 for coupling to the bulb unit 30 are disposed behind the lampshade 301 and extend from the lampshade 301 in a direction perpendicular to the bottom seat 42. The power connector 48 is disposed on the bottom seat 42 below the lampshade 301 with the socket 4802 extending perpendicularly from the bottom seat 42 to receive the conductive legs 3002 therein.

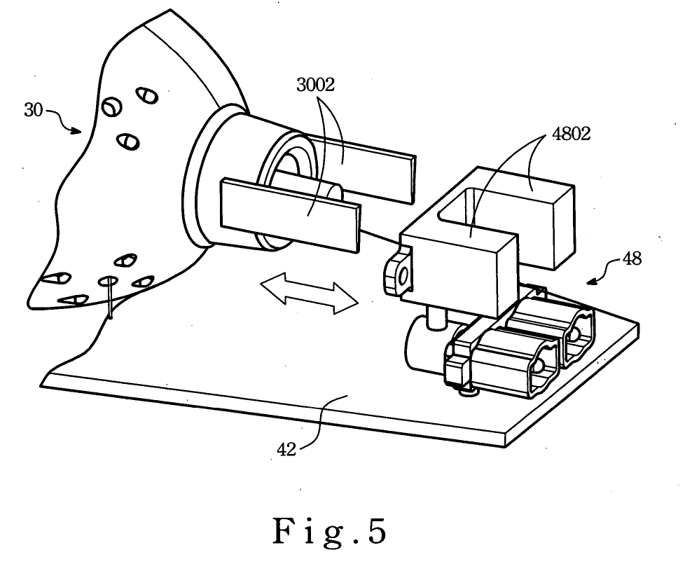

Alternately, in another embodiment, the tending direction of the conductive legs 3002 can be altered. Referring to FIG. 5, the conductive legs 3002 extend rearwardly from the lampshade 301 in a direction parallel to the bottom seat 42. The power connector 48 is disposed right behind the lampshade 301 in such a manner that the sockets 4802 are disposed in alignment with for receiving the conductive legs 3002 therein.

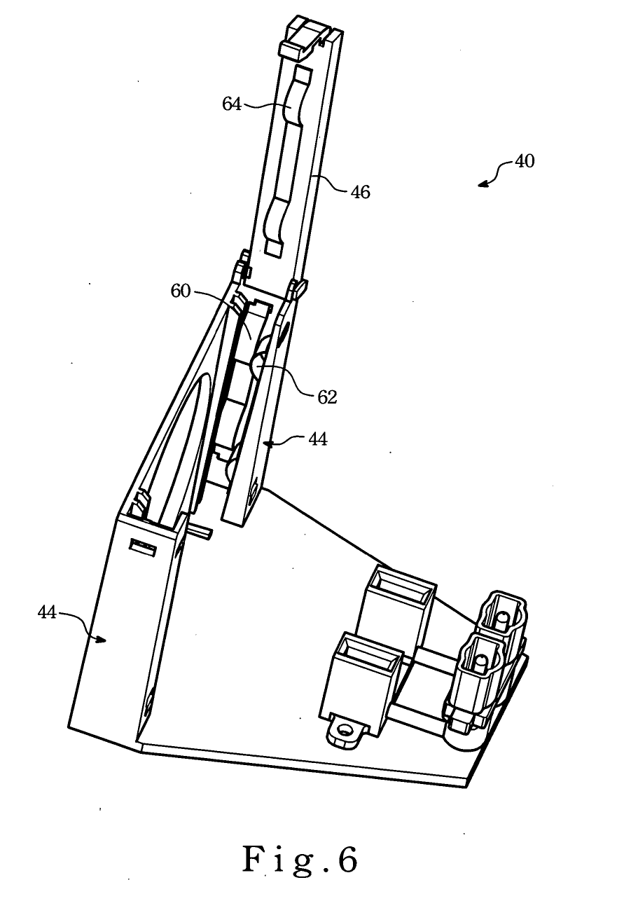

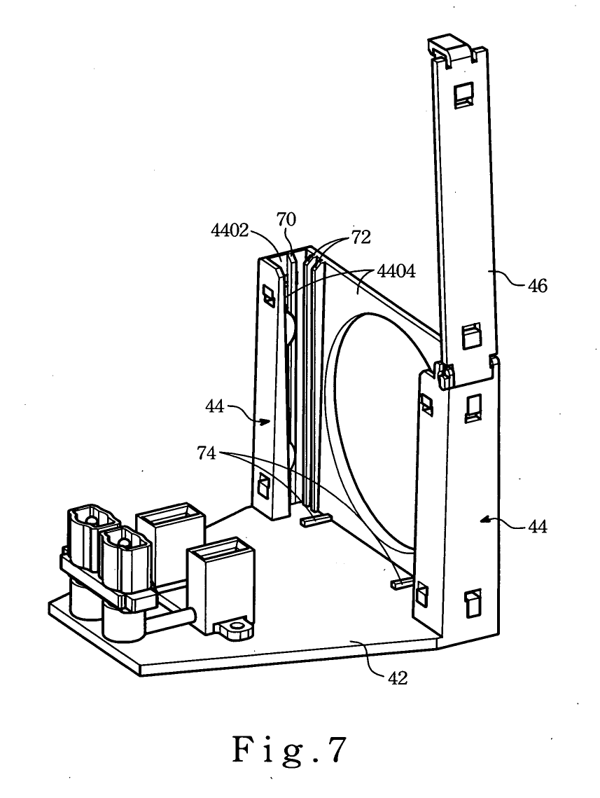

Referring to FIG. 6, the right retention channel 44″ in the right mounting posts 44 is composed by a first and two second side surfaces 4402, 4404 (see FIG. 7). The seat assembly 40 of the present invention further includes first, second and third resilient spring members 60, 62, 64. The first resilient spring member 60 is disposed on the first side surface 4402 of the right retention channel 44″ in the right mounting posts 44, and contacts resiliently the right flange 3004 of the bulb unit 30. The right retention channel 44″ in the right mounting post 44 further has two second side surfaces 4404 extending respectively and perpendicularly from two opposite ends of the first side surface 4402. The second resilient spring member 62 is disposed on one of the second side surfaces 4404 of the right retention channel for providing a sliding contact with the right flange 3004 of the bulb unit 30. In the same manner, the third resilient spring member 64 is disposed on an inner surface 4602 of the bridging post 46 for resiliently contacting an upper flange of the bulb unit 30 interconnecting the left and right flanges 3004.

An important aspect to note that the structure and configuration of the first, second and third resilient spring members 60, 62, 64 differ from one another according to the design of the retention channels 44″, but they should provide resilient restoration force once the applied force is removed therefrom.

Referring to FIG. 7, The seat assembly 40 according to the present invention further includes first, second and third positioning ribs 70, 72, 74. The first positioning rib 70 is disposed on the first side surface 4402 of the left retention channel 44″ in the left mounting post 44, and contacts the left flange 3004 of the bulb unit 30 in order to reduce a total contact area and a wear between the left flange and the left retention channel 44″.

Moreover, the left retention channel 44″ in the left mounting post 44 has two second side surfaces 4404 respectively extending perpendicularly from two opposite ends s of the first side surface 4402. The second resilient spring member 62 is disposed on one of the second side surfaces 4402 of the left retention channel 44″ in the left mounting post 44. The second positioning ribs 72 are disposed on the other one of the second side surfaces 4404 of the left retention channel 44″ for providing a sliding contact with the left flange 3004 of the bulb unit 30 in order to reduce the total contact area and a wear between the left flange 3004 and the left retention channel.

Referring again to FIG. 7, the third positioning ribs 74 are disposed on the bottom seat 42 adjacent to the front end thereof for providing a sliding contact between a lower flange 3004 of the bulb unit 30 and the bottom seat 42 in order to reducing a total contact area and a wear between the lower flange and the bottom seat 42. The lower flange is interposed between the left and right flanges of the bulb unit 30. Formation of the rib sections can economize the material for construction of the positioning ribs.

An important aspect to note that the structure and configuration of the first, second and third positioning ribs 70, 72, 74 differ from one another according to the design of the retention channels 44″, but they minimize the total contact area and wears between the flanges of the bulb unit 30 and the channels in the mounting posts 44.

To summarize the above paragraphs, it is observable that it is relatively easy to remove the damage bulb unit 30 from the lamp seat assembly 40 of the present invention. In addition, the left and right mounting posts 44 and the bridging post 46 constituting components of the seat assembly 40 are not discarded along with the damaged bulb unit, but are reusable again.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A seat assembly for seating a bulb unit securely within a projection apparatus, the bulb unit having two conductive legs, the seat assembly comprising:
a bottom seat for holding the bulb unit thereon; and
a power connector disposed on said bottom seat and adapted to be connected electrically to a power supply of the projection apparatus, said power connector adapted to be coupled electrically to the conductive legs of the bulb unit.

2. The seat assembly according to claim 1, wherein said power connector is formed with two leg-receiving sockets for respectively receiving the conductive legs of the bulb unit.

3. The seat assembly according to claim 2, wherein the bulb unit includes a lampshade, the conductive legs being disposed behind the lampshade and extending from said lampshade in a parallel manner with respect to said bottom seat, said power connector being disposed right behind the lampshade in such a manner that said leg-receiving sockets are disposed in alignment with for receiving the conductive legs therein.

4. The seat assembly according to claim 2, wherein the bulb unit includes a lampshade, the conductive legs being disposed behind and extending from the lampshade in a direction perpendicular to said bottom seat, said power connector being disposed on said bottom seat below said lampshade with said leg-receiving socket extending perpendicularly from said bottom seat to receive the conductive legs therein.

5. The seat assembly according to claim 1, wherein said power connector is formed with two leg-receiving sockets, the bulb unit including a lampshade, and left and right flanges extending laterally from opposite left and right sides of the lampshade, the seat assembly further comprising spaced apart left and right mounting posts extending upwardly from a front end of said bottom seat to define left and right retention channels for receiving the left and right flanges of the bulb unit so as to retain the bulb unit on said bottom seat with the conductive legs being received in said leg-receiving sockets, each of said left and right retention channels having a first side surface and two second side surfaces extending from two opposite ends of said first side surface.

6. The seat assembly according to claim 5, further comprising a first resilient spring member 60 that is disposed on said first side surface of said right retention channel in said right mounting posts and that contacts resiliently the right flange of the bulb unit.

7. The seat assembly according to claim 6, further comprising a first positioning rib that is disposed on said first side surface of said left retention channel in said left mounting post and that contacts the left flange of the bulb unit in order to reduce a total contact area and a wear between the left flange and said left retention channel.

8. The seat assembly according to claim 5, wherein said second side surfaces extend respectively perpendicularly from said first side surface, the seat assembly further comprising a second resilient spring member disposed on one of said second side surfaces of said right retention channel for providing a sliding contact with the right flange of the bulb unit.

9. The seat assembly according to claim 8, further comprising a second positioning rib disposed on the other one of said second side surface of said left retention channel for providing a sliding contact with the left flange of the bulb unit in order to reduce said total contact area and a wear between the left flange and said left retention channel.

10. The seat assembly according to claim 5, further comprising a bridging post that spans across said left and right mounting posts and that has one end connected pivotally to said right mounting post and the other end fastened detachably to said left mounting post in order to enhance retaining of said lampshade with respect to said bottom seat.

11. The seat assembly according to claim 10, wherein said bridging post, said left and right mounting posts and a portion of said bottom seat cooperatively define a rectangular frame.

12. The seat assembly according to claim 11, wherein the bulb unit further has an upper flange interconnecting the left and right flanges, the seat assembly further comprising a third resilient spring member disposed on an inner surface of said bridging post for resiliently contacting the upper flange of the bulb unit.

13. The seat assembly according to claim 12, wherein the bulb unit further has a lower flange interconnecting the left and right flanges, the seat assembly further comprising a third positioning rib disposed on said bottom seat adjacent to said front end thereof for providing a sliding contact between the lower flange of the bulb unit and said bottom seat in order to reducing a total contact area between the lower flange and said bottom seat.

14. A seat assembly 40 for seating a bulb unit 30 securely within a projection apparatus, the bulb unit having outwardly extending left and right flanges, the seat assembly comprising:
a bottom seat for holding the bulb unit thereon; and
two left and right mounting posts extending upwardly from a front end of said bottom seat to define left and right retention channels for receiving the left and right flanges of the bulb unit so as to retain the bulb unit on said bottom seat.

15. The seat assembly according to claim 14, further comprising a first resilient spring member that is disposed on a first side surface of said right retention channel in said right mounting posts and that contacts resiliently the right flange of the bulb unit.

16. The seat assembly according to claim 15, further comprising a first positioning rib that is disposed on said first side surface of said left retention channel in said left mounting post and that contacts the left flange of the bulb unit in order to reduce a total contact area and a wear between the left flange and said left retention channel.

17. The seat assembly according to claim 14, wherein said right retention channel in said right mounting post further has two second side surfaces extending respectively perpendicularly from said first side surface, the seat assembly further comprising a second resilient spring member disposed on one of said second side surfaces of said right retention channel for providing a sliding contact with the right flange of the bulb unit.

18. The seat assembly according to claim 17, wherein said second side surfaces respectively perpendicularly extend from said first side surface, the seat assembly further comprising a second positioning rib disposed on the other one of said second side surfaces of said left retention channel for providing a sliding contact with the left flange of the bulb unit in order to reduce said total contact area between the left flange and said left retention channel.

19. The seat assembly according to claim 14, further comprising a bridging post that spans across said left and right mounting posts and that has one end connected pivotally to said right mounting post and the other end fastened detachably to said left mounting post in order to enhance retaining of the bulb unit with respect to said bottom seat.

20. The seat assembly according to claim 19, wherein said bridging post, said left and right mounting posts and a portion of said bottom seat cooperatively define a rectangular frame.

21. The seat assembly according to claim 19, wherein the bulb unit further has an upper flange interconnecting the left and right flanges, the seat assembly further comprising a third resilient spring member disposed on an outer surface of said bridging post for resiliently contacting the upper flange of the bulb unit.

22. The seat assembly according to claim 21, wherein the bulb unit further has a lower flange interconnecting the left and right flanges, the seat assembly further comprising a third positioning rib disposed on an outer surface of said bottom seat adjacent to said front end thereof for providing a sliding contact between the lower flange of the bulb unit and said bottom seat in order to reducing a total contact area between the lower flange and said bottom seat.

23. The seat assembly according to claim 14, wherein the bulb unit includes two conductive legs, the seat assembly further comprising a power connector disposed on said bottom seat and adapted to be connected electrically to a power supply of the projection apparatus, said power connector adapted to be coupled electrically to the conductive legs of the bulb unit.

24. The seat assembly according to claim 23, wherein said power connector is formed with two leg-receiving sockets for respectively receiving the conductive legs of the bulb unit.

25. The seat assembly according to claim 24, wherein the bulb unit further includes a lampshade, the conductive legs being disposed behind the lampshade and extending rearward from said lampshade in a parallel manner with respect to said bottom seat, said power connector being disposed right behind the lampshade in such a manner that said sockets are disposed in alignment with for receiving the conductive legs therein.

26. The seat assembly according to claim 24, wherein the bulb unit includes a lampshade, the conductive legs being disposed behind and extending from the lampshade in a direction perpendicular to said bottom seat, said power connector being disposed below said lampshade with said socket extending perpendicularly from said bottom seat to receive the conductive legs therein.
